(19) United States
(12) Patent Application Publication
(10) Pub. No.: US 2025/0124337 A1
(43) Pub. Date: Apr. 17, 2025

(54) System and Method for Cloud-based Training and Management of Storage Performance Forecast Machine Learning Models for Storage Systems

(71) Applicant: Dell Products L.P., Round Rock, TX (US)

(72) Inventors: Shaul Dar, Petach Tikva (IL); Zachary Wellington Arnold, Royal Oak, MI (US); Michael Scott Barnes, Doylestown, PA (US); David Sydow, Merrimack, NH (US); Michael Burns, Shrewsbury, MA (US); Nikarika Karia, Tewksbury, MA (US); Sumantia Kashyapi, Worchester, PA (US)

(21) Appl. No.: 18/484,545

(22) Filed: Oct. 11, 2023

(51) Int. Cl. G06N 20/00

(52) U.S. Cl. CPC G06N 20/00

(57) ABSTRACT

A method, computer program product, and computing system for generating a plurality of trained machine learning models using a cloud computing system by training a plurality of machine learning models to forecast storage performance for one or more storage objects of a storage system, wherein the cloud computing system is separate from any storage system. A trained machine learning model is selected from the plurality of trained machine learning models to deploy to a target storage system. The trained machine learning model is deployed on the target storage system.

### BACKGROUND

Modern information technology (IT) systems, and in particular storage devices, are becoming more and more intelligent. Customers expect these system not only to process massive amounts of input/output (IO) requests, but also to monitor the system operation, detect and alert on anomalous behaviors, forecast future performance and potential failures and proactively help the administrators resolve issues in advance, and in general automate all the relevant IT assets and processes, and thus free the customers to focus on their business. In addition, the ability to model and characterize the IO activity of objects such as files, volumes, or extents, in a storage system, can enable many specialized optimizations and significant performance gains.

Training a machine learning model on a production server storage system can be resource and time intensive. For example, training a temperature forecasting model for millions of slices on a typical storage system, using four cores, may take an hour. In contrast, using such a machine learning model for inference may take about a minute. Additionally, many server and storage devices typically do not have a GPU, which can be very useful for accelerating model training time by order of magnitude (and much less important for accelerating model inference time). Also, in many use cases, training a machine learning model on multiple production storage systems is redundant and wasteful since the relevant machine learning model is the same.

### SUMMARY OF DISCLOSURE

In one example implementation, a computer-implemented method executed on a computing device may include, but is not limited to, generating a plurality of trained machine learning models using a cloud computing system by training a plurality of machine learning models to forecast storage performance for one or more storage objects of a storage system, wherein the cloud computing system is separate from any storage system. A trained machine learning model is selected from the plurality of trained machine learning models to deploy to a target storage system. The trained machine learning model is deployed on the target storage system.

One or more of the following example features may be included. Selecting the trained machine learning model from the plurality of trained machine learning models may include performing a champion-challenger process with the plurality of trained machine learning models. Performing the champion-challenger process may include: generating a short-term forecast with each trained machine learning model; generating a long-term forecast with each trained machine learning model; determining a weighted symmetric mean absolute percentage (SMAPE) for the short-term forecast of each trained machine learning model; determining a weighted SMAPE for the long-term forecast of each trained machine learning model; and generating a weighted total SMAPE for each trained machine learning model. Selecting the trained machine learning model from the plurality of trained machine learning models may include selecting the trained machine learning model using a static ruleset that describes one or more model inference performance constraints associated with the target storage system. A model inference result associated with the deployment of the trained machine learning model on the target storage system may be received. The trained machine learning model may be updated using the cloud computing system based upon, at least in part, the model inference result. Updating the trained machine learning model may include detecting a drift in performance associated with the trained machine learning model.

In another example implementation, a computer program product resides on a computer readable medium that has a plurality of instructions stored on it. When executed by a processor, the instructions cause the processor to perform operations that may include, but are not limited to, generating a plurality of trained machine learning models using a cloud computing system by training a plurality of machine learning models to forecast storage performance for one or more storage objects of a storage system, wherein the cloud computing system is separate from any storage system. A trained machine learning model is selected from the plurality of trained machine learning models to deploy to a target storage system. The trained machine learning model is deployed on the target storage system.

One or more of the following example features may be included. Selecting the trained machine learning model from the plurality of trained machine learning models may include performing a champion-challenger process with the plurality of trained machine learning models. Performing the champion-challenger process may include: generating a short-term forecast with each trained machine learning model; generating a long-term forecast with each trained machine learning model; determining a weighted symmetric mean absolute percentage (SMAPE) for the short-term forecast of each trained machine learning model; determining a weighted SMAPE for the long-term forecast of each trained machine learning model; and generating a weighted total SMAPE for each trained machine learning model. Selecting the trained machine learning model from the plurality of trained machine learning models may include selecting the trained machine learning model using a static ruleset that describes one or more model inference performance constraints associated with the target storage system. A model inference result associated with the deployment of the trained machine learning model on the target storage system may be received. The trained machine learning model may be updated using the cloud computing system based upon, at least in part, the model inference result. Updating the trained machine learning model may include detecting a drift in performance associated with the trained machine learning model.

In another example implementation, a computing system includes at least one processor and at least one memory architecture coupled with the at least one processor, wherein the at least one processor is configured to generate a plurality of trained machine learning models using a cloud computing system by training a plurality of machine learning models to forecast storage performance for one or more storage objects of a storage system, wherein the cloud computing system is separate from any storage system. A trained machine learning model is selected from the plurality of trained machine learning models to deploy to a target storage system. The trained machine learning model is deployed on the target storage system.

One or more of the following example features may be included. Selecting the trained machine learning model from the plurality of trained machine learning models may include performing a champion-challenger process with the plurality of trained machine learning models. Performing the champion-challenger process may include: generating a short-term forecast with each trained machine learning model; generating a long-term forecast with each trained machine learning model; determining a weighted symmetric mean absolute percentage (SMAPE) for the short-term forecast of each trained machine learning model; determining a weighted SMAPE for the long-term forecast of each trained machine learning model; and generating a weighted total SMAPE for each trained machine learning model. Selecting the trained machine learning model from the plurality of trained machine learning models may include selecting the trained machine learning model using a static ruleset that describes one or more model inference performance constraints associated with the target storage system. A model inference result associated with the deployment of the trained machine learning model on the target storage system may be received. The trained machine learning model may be updated using the cloud computing system based upon, at least in part, the model inference result. Updating the trained machine learning model may include detecting a drift in performance associated with the trained machine learning model.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a distributed model training process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of distributed model training process according to one or more example implementations of the disclosure; and

FIG. 4 is an example diagrammatic view of the distributed model training process according to one or more example implementations of the disclosure.

Like reference symbols in the various drawings indicate like elements.

### DETAILED DESCRIPTION

### System Overview

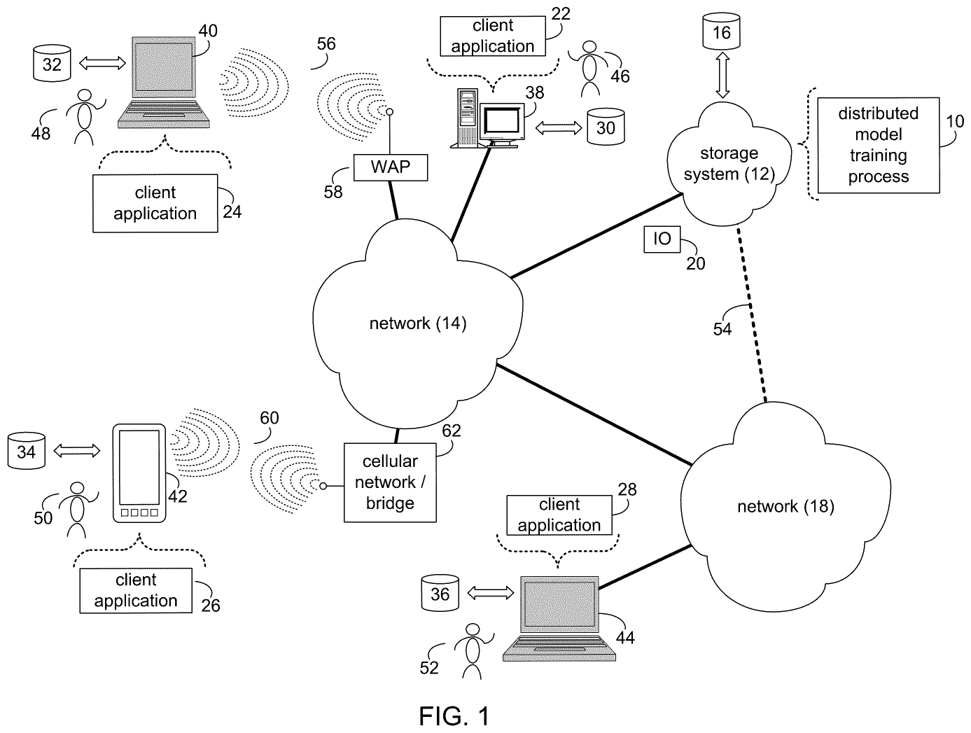

Referring to FIG. 1, there is shown distributed model training process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of distributed model training process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of distributed model training process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a distributed model training process, such as distributed model training process 10 of FIG. 1, may include but is not limited to, generating a plurality of trained machine learning models using a cloud computing system by training a plurality of machine learning models to forecast storage performance for one or more storage objects of a storage system, wherein the cloud computing system is separate from any storage system. A trained machine learning model is selected from the plurality of trained machine learning models to deploy to a target storage system. The trained machine learning model is deployed on the target storage system.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

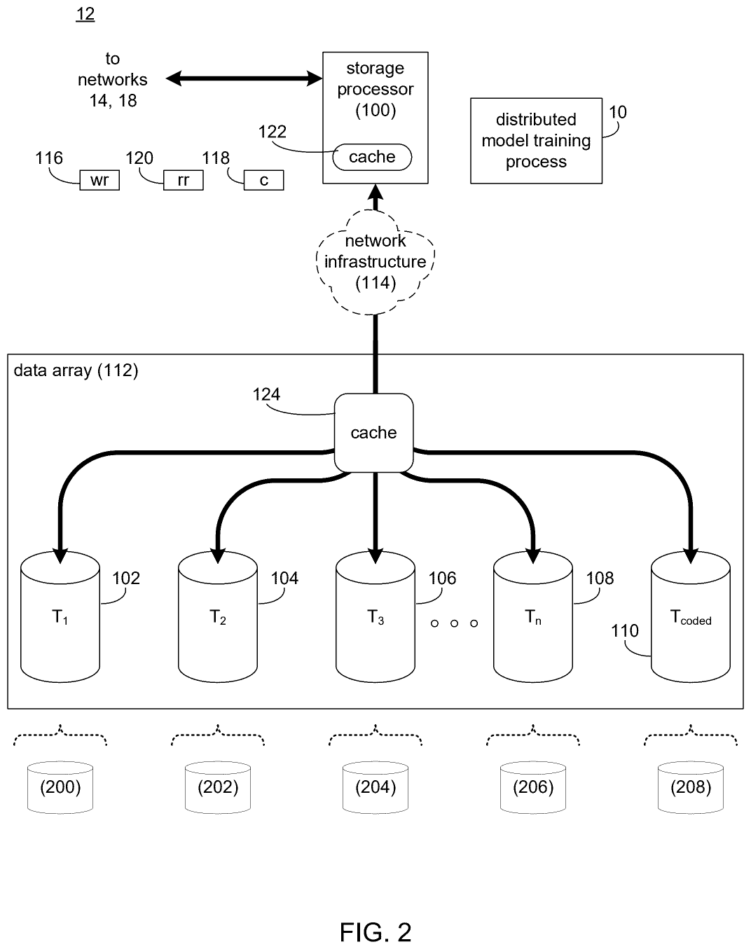

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of distributed model training process 10. The instruction sets and subroutines of distributed model training process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of distributed model training process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g., one or more of storage targets 102, 104, 106, 108, and coded target 110.

As discussed above, the instruction sets and subroutines of distributed model training process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of distributed model training process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

### The Distributed Model Training Process

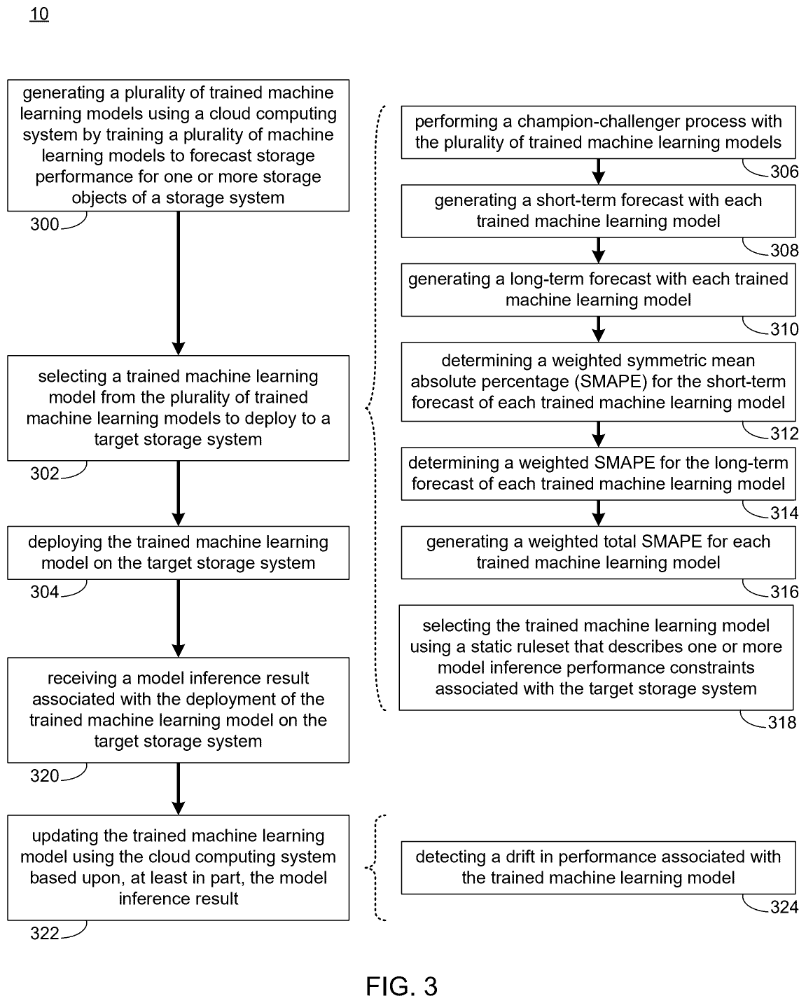

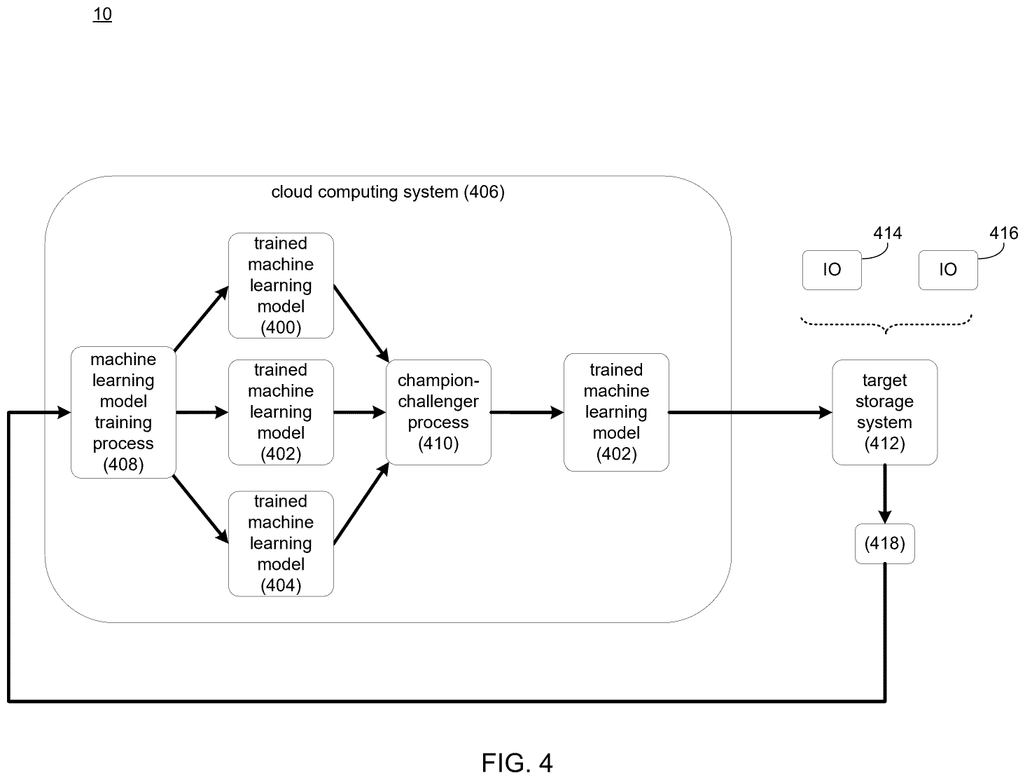

Referring also to the examples of FIGS. 3-4 and in some implementations, distributed model training process 10 may generate 300 a plurality of trained machine learning models using a cloud computing system by training a plurality of machine learning models to forecast storage performance for one or more storage objects of a storage system, wherein the cloud computing system is separate from any storage system. A trained machine learning model is selected 302 from the plurality of trained machine learning models to deploy to a target storage system. The trained machine learning model is deployed 304 on the target storage system.

As will be discussed in greater detail below, implementations of the present disclosure allow for the distributed training of machine learning models on a cloud computing system and selective deployment to target storage systems based on the relative performance characteristics of each trained machine learning model. In this manner, the computing demand associated with training machine learning models is deployed on cloud computing systems while model inference is performed on the target storage systems. Additionally, implementations of the present disclosure allow for trained machine learning models to be customized for deployment in particular storage systems while forming a feedback loop to continuously improve the training of machine learning models and the selection of particular machine learning models for target storage systems. For example, modern information technology (IT) systems, and in particular storage devices, are becoming more and more intelligent. Customers expect these system not only to process massive amounts of input/output (IO) requests, but also to monitor the system operation, detect and alert on anomalous behaviors, forecast future performance and potential failures and proactively help the administrators resolve issues in advance, and in general automate all the relevant IT assets and processes, and thus free the customers to focus on their business. In addition, the ability to model and characterize the IO activity of objects such as files, volumes, or extents, in a storage system, can enable many specialized optimizations and significant performance gains.

Training a machine learning model on a production server storage system can be resource and time intensive. For example, training a temperature forecasting model for millions of slices on a typical storage system, using four cores, may take an hour. In contrast, using such a machine learning model for inference may take about a minute. Additionally, many server and storage devices typically do not have a GPU, which can be very useful for accelerating model training time by order of magnitude (and much less important for accelerating model inference time). Also, in many use cases, training a machine learning model on multiple production storage systems is redundant and wasteful since the relevant machine learning model is the same.

In the specific case of performance forecasting, there are two distinct issues that are addressed when implementing the solution on an embedded system with limited compute and memory resources. First, it is not possible to select a single static model that performs best at forecasting IO patterns for an individual storage system, as the patterns can vary with daily, weekly, monthly, or even yearly seasonal trends. Second, many storage systems, especially in the mid-range market, have highly variable internal configurations with a significant difference in the amount of compute and memory available to internal processes such as machine learning model forecasting algorithms.

Accordingly, implementations of the present disclosure provide the following benefits:
Cloud-based training and evaluation of machine learning models used to forecast the performance of a storage system;
Filtering and distribution of specific storage system performance forecasting machine learning models based on specific hardware configurations; and
A feedback loop using inference from individual hardware models to improve cloud-based training and model selection.

Accordingly, this approach offloads the heavy training process from the servers and arrays, and can use scalable and shared cloud data, and elastic compute infrastructure including disks, RAM, CPUs and GPUs. In addition, trained machine model learning models are customized to specific attributes of a target storage system.

In some implementations, distributed model training process 10 generates 300 a plurality of trained machine learning models using a cloud computing system by training a plurality of machine learning models to forecast storage performance for one or more storage objects of a storage system, where the cloud computing system is separate from any storage system. A machine learning model generally includes an algorithm or combination of algorithms that has been trained to recognize certain types of patterns. For example, machine learning approaches may be generally divided into three categories, depending on the nature of the signal available: supervised learning, unsupervised learning, and reinforcement learning. Supervised learning may include presenting a computing device with example inputs and their desired outputs, given by a “teacher”, where the goal is to learn a general rule that maps inputs to outputs. With unsupervised learning, no labels are given to the learning algorithm, leaving it on its own to find structure in its input. Unsupervised learning can be a goal in itself (discovering hidden patterns in data) or a means towards an end (feature learning). Reinforcement learning may generally include a computing device interacting in a dynamic environment in which it must perform a certain goal (such as driving a vehicle or playing a game against an opponent). As it navigates its problem space, the machine learning model is provided feedback that is analogous to rewards, which it tries to maximize. While three examples of machine learning approaches have been provided, it will be appreciated that other machine learning approaches are possible within the scope of the present disclosure.

Referring again to FIG. 2, during the operation of a storage system (e.g., storage system 12), IO requests may be generated for processing data on various storage objects (e.g., storage objects 200, 202, 204, 206, 208). Storage objects (e.g., storage objects 200, 202, 204, 206, 208) may generally include any container or storage unit configured to store data within a storage system (e.g., storage system 12). For example, a storage object may be any one of the following: a volume (aka Logical Unit Number (LUN)), a file, or parts thereof that may be defined e.g., by offsets or address ranges (e.g., sub-LUNs, disk extents, and/or slices).

Referring also to FIG. 4 and in some implementations, distributed model training process 10 generates 300 a plurality of trained machine learning models (e.g., trained machine learning models 400, 402, 404) using a cloud computing system (e.g., cloud computing system 406). A cloud computing system (e.g., cloud computing system 406) generally includes one or more remote servers connected through the Internet to store, manage, and process data, providing on-demand access to computing resources without the need for local infrastructure. In some implementations, cloud computing system 406 is physically separate from any storage systems but connected using the Internet. In this manner, cloud computing system 406 may be connected to many storage systems at the same time and/or may be able to communicate with various storage systems. In the example of FIG. 4, cloud computing system 406 may include various computing resources to enhance machine learning model training. For example, cloud computing system 406 may include specialized hardware like Graphics Processing Units (GPUs) and Tensor Processing Units (TPUs). Additionally, cloud computing system 406 may be configured for parallel processing, which is effective for matrix calculations involved in training machine learning models. In some implementations, cloud computing system 406 may include high-performance Central Processing Units (CPUs), fast storage, and significant amounts of Random Access Memory (RAM). In this manner, cloud computing system 406 may include the hardware and/or software components to more efficiently train machine learning models that can be deployed to “edge” target storage systems.

Referring again to FIG. 4, distributed model training process 10 generates 300 trained machine learning models 400, 402, 404 by processing various types and quantities of training data. Training data is any information provided to a machine learning model to “train” the model to provide desired output for known inputs. In this manner, each trained machine learning model may be trained with data from particular types or categories of storage systems (e.g., for storage systems with a particular, known configuration) and/or for specific storage systems with known IO request patterns or other known usage patterns. In some implementations, generating 300 trained machine learning models 400, 402, 404 is shown in FIG. 4 as machine learning model training process 408. As will be discussed in greater detail below, distributed model training process 10 uses machine learning model training process 408 to update or retrain trained machine learning models 400, 402, 404.

In some implementations, distributed model training process 10 selects 302 a trained machine learning model from the plurality of trained machine learning models to deploy to a target storage system. For example, distributed model training process 10 is able to select a best trained machine learning model for a particular storage system. In some implementations, the trained machine learning model is selected for its applicability to a target storage system based upon, at least in part, the configuration of the target storage system and/or the nature of the IO requests being processed by the target storage system. For example and as will be discussed in greater detail below, each storage system may include unique hardware and/or software configurations that may impact the performance of the storage system during machine learning model inference (i.e., using the trained machine learning model to perform a particular task (e.g., forecast a temperature for a storage object, forecast when to tier or re-tier a storage object, etc.)). Additionally, the nature or pattern of IO requests may impact the accuracy of a given trained machine learning model. For example, suppose that a target storage system receives a particular pattern of IO requests that generally follow a temporal pattern (e.g., long periods of a first rate of IO request processing with short, highly intensive IO requests at a second rate). In this example, multiple machine learning models may be used at different times based upon, at least in part, the pattern of IO request processing.

In some implementations, selecting 302 the trained machine learning model from the plurality of trained machine learning models includes performing 306 a champion-challenger process with the plurality of trained machine learning models. A champion challenger strategy is a valuable approach in machine learning that offers several benefits. By employing this strategy, machine learning models can be continuously improved and may drive innovation. The “champion” represents the existing trained machine model or solution that is performing best among the plurality of trained machine learning models, while “challengers” are alternative trained machine models or approaches introduced for comparison. In one example, suppose seven machine learning models are trained by cloud computing system 406 as shown below in Table 1:

TABLE 1
Machine Learning Model
ARIMA
AutoARIMA
SARIMA
XGBoost
Prophet
LSTM
DeepAR

In this example with these particular trained machine learning models, it is assumed that the trained machine learning models perform a univariate prediction using a single “headroom” value, representing overall performance capacity in the target storage system. For storage systems without this concept, this technique could also be applied to other values such as IO per second (IOPs) or CPU usage with lower accuracy.

In some implementations, performing 306 the champion-challenger process includes: generating 308 a short-term forecast with each trained machine learning model; generating 310 a long-term forecast with each trained machine learning model; determining 312 a weighted symmetric mean absolute percentage error (SMAPE) for the short-term forecast of each trained machine learning model; determining 314 a weighted SMAPE for the long-term forecast of each trained machine learning model; and generating 316 a weighted total SMAPE for each trained machine learning model. For example and continuing with the above example of forecasting storage capacity, two points may be considered in the exemplary champion-challenger process (e.g., champion-challenger process 410): short-term and long-term training data to provide maximum accuracy; and SMAPE to evaluate forecast accuracy. In some implementations, distributed model training process 10 generates a short-term forecast with each training machine learning model by training each machine learning model using an 80:20 test/train split for on a predefined sampling of data (e.g., 1 day of customer performance data with a fidelity of 5-minute average performance). In this example, the training and test data is based on historical information stored in cloud computing system 406 no more than 1 hour old. However, it will be appreciated that any predefined sampling of data may be used for generating 308 the short-term forecast for each training machine learning model within the scope of the present disclosure.

Continuing with above example involving machine learning models trained to perform storage capacity forecasting, distributed model training process 10 may generate 310 a long-term forecast with each trained machine learning model by training each machine learning model using an 80:20 test/train split on a predefined period of data (e.g., six months of customer performance data with a fidelity of one day average performance). In this example, the training and test data is based on historical information stored in the cloud no more than 6 months old. However, it will be appreciated that any predefined period of data may be used for generating 310 the long-term forecast for each training machine learning model within the scope of the present disclosure.

In some implementations, distributed model training process 10 determines 312 a weighted SMAPE for the short-term forecast of each trained machine learning model and determines 314 a weighted SMAPE for the long-term forecast of each trained machine learning model. For example, both the long term and short-term prediction for each machine learning model are evaluated against the test dataset to determine accuracy. In some implementations, a symmetric mean absolute percentage error (SMAPE) is a metric used to assess the accuracy of forecasting or prediction methods. It measures the percentage of difference between predicted and actual values, considering their absolute difference in the numerator and the sum of their absolute values in the denominator. The symmetry in SMAPE comes from averaging the percentage errors for both overestimates and underestimations. As such, it generally provides a balanced view of forecasting accuracy. Continuing with the above example, distributed model training process 10 applies different weighting to each of the short-term forecast and the long-term forecast. In one example, distributed model training process 10 determines 312 the SMAPE for the short-term forecast and weights it by multiplying the result by 0.7. In this example, distributed model training process 10 determines 314 the SMAPE for the long-term forecast and weights it by multiplying the result by 0.3. Distributed model training process 10 generates 316 a weighted total SMAPE for each trained machine learning model by adding the weighted SMAPE for the short-term forecast to the weighted SMAPE for the long-term forecast.

With a weighted total SMAPE for each trained machine learning model, the performance of each trained machine learning model is quantified with a single value. As such, distributed model training process 10 selects 302 a trained machine learning model for deploying to a target storage system based upon, at least in part, the weighted total SMAPE for each trained machine learning model. In one example, distributed model training process 10 compares the weighted total SMAPEs for each trained machine learning model and selects 302 the trained machine learning model with the lowest weighted SMAPE value as the “champion” trained machine learning model. In some implementations, distributed model training process 10 retains or stores the weighted SMAPE value from the champion trained machine learning model along with a descriptor or reference for a target storage system in a database. In the above example, the selecting of trained machine learning models values accuracy in long-term forecast over accuracy in short-term forecast, because workloads can be very unpredictable in the short term, and while some short-term forecasting is useful for predicting and preventing potential service slowdowns, it is not as valuable as long-term forecasting for the purpose of workload planning. However, it will be appreciated that various weighting schemes can be used to account for different objectives within the scope of the present disclosure.

In some implementations, selecting 302 the trained machine learning model from the plurality of trained machine learning models includes selecting 318 the trained machine learning model using a static ruleset that describes one or more model inference performance constraints associated with the target storage system. For example, distributed model training process 10 may provide model selection or customization based upon a static ruleset which filters the class of trained machine learning models that can be selected in the champion/challenger strategy discussed above. In some implementations, the static ruleset may be described in a JSON format using they key/value pairs described in Table 2 shown below:

TABLE 2

| Attribute | Values | Description |
|---|---|---|
| Model | String | This will be the model of |
| | | the storage system |
| CPU_constrained | Boolean | True if low CPU resources |
| | | exclude CPU-intensive |
| | | trained machine learning |
| | | models |
| Memory_constrained | Boolean | True if low memory |
| | | resources exclude memory- |
| | | intensive trained machine |
| | | learning models |

Note that for this example, trained machine learning models are grouped into two simple categories based on CPU and memory constraints. However, it will be appreciated that any number of categories or attributes may be used in a static ruleset to select 318 a particular trained machine learning model for a target storage system. In some implementations, the static ruleset may be implemented as a JSON file as shown below:

| { | |
|---|---|
| [ | |
| “model” | : “Model 1000”, |
| “CPU_constrained” | : “Yes”, |
| “Memory_constrained” | : “No” |
| ], | |
| [ | |
| “model” | : “Model 2500T”, |
| “cpu_constrained” | : “No”, |
| “memory_constrained” | : “No” |

]
}

Continuing with the above example where e.g., seven trained machine learning models are compared using champion-challenger process 410, distributed model training process 10 may use the static ruleset as shown in Table 3 below to filter the selection of particular trained machine learning models for specific target storage systems:

TABLE 3

| Machine | CPU | Memory |
|---|---|---|
| Learning Model | constrained? | constrained? |
| ARIMA | Yes | Yes |
| AutoARIMA | No | No |
| SARIMA | Yes | Yes |
| XGBoost | Yes | Yes |
| Prophet | Yes | Yes |
| LSTM | No | No |
| DeepAR | No | No |

In some implementations, distributed model training process 10 deploys 304 the trained machine learning model on the target storage system. Referring again to FIG. 4, suppose champion-challenger process 410 selects trained machine learning model 402 as the winner. In this example, distributed model training process 10 deploys 304 trained machine learning model 402 by providing or transmitting trained machine learning model 402 in its entirety, or by providing hyperparameters and other weighting configuration information to adjust trained machine learning model 402 when processing IO requests on the target storage system (e.g., target storage system 412).

In some implementations, distributed model training process 10 receives 320 a model inference result associated with the deployment of the trained machine learning model on the target storage system. For example, in response to deploying 304 the trained machine learning model, target storage system 412 may begin to process IO requests (e.g., IO requests 414, 416) to perform a task involving trained machine learning model 402. In one example, suppose trained machine learning model 402 is specialized in forecasting a storage object temperature (i.e., a value indicative of the likelihood that the storage object will be accessed within a particular period of time). In this example, distributed model training process 10 uses trained machine learning model 402 at inference time/run time to forecast when the temperature of specific storage objects. As target storage system 412 generates storage object temperature forecasts, distributed model training process 10 may store model inference results on target storage system 412 to record the accuracy of trained machine learning model 402. In one example, distributed model training process 10 may receive 320 the model inference request (e.g., model inference result 418) after requesting model inference result 418. In some implementations, the request for model inference result 418 may be periodically provided to target storage system 412. The periodicity may be a default value, may be automatic, or may be user-defined. In some implementations, distributed model training process 10 may provide model inference result 418 periodically to cloud computing system 406. The periodicity may be a default value, may be automatic, or may be user-defined.

In some implementations, distributed model training process 10 updates 322 the trained machine learning model using the cloud computing system based upon, at least in part, the model inference result. For example, distributed model training process 10 provides a feedback loop where model inference result 418 is used to update 322 the training of the plurality of machine learning models. For example, suppose target storage system 402 processes a plurality of IO requests (e.g., IO requests 414, 416) over a period of time. During model inference using trained machine learning model 402, the accuracy of trained machine learning model 402 may be decrease or may be enhanced with the addition of updated training data using model inference result 418. Accordingly, distributed model training process 10 uses model inference result 418 to improve training data for machine learning model training process 408. In some implementations, when updating 322 the trained machine learning model using the cloud computing system, distributed model training process 10 may update the training of each machine learning model of the plurality of machine learning models. In some implementations, updating 322 the trained machine learning model may include selecting 302 or updating the selection of the trained machine learning model for target storage system 412 by performing 306 champion-challenger process 410 with the plurality of trained machine learning models.

In some implementations, updating 322 the trained machine learning model includes detecting 324 a drift in performance associated with the trained machine learning model. For example, because the performance profile of each individual storage system may change over time, distributed model training process 10 may continuously re-evaluate the accuracy of trained machine learning models deployed on each storage system with some frequency. Even with elastic cloud-based computing, evaluating multiple machine learning models for every storage system in the field at a high frequency can quickly run into problems at scale. Therefore, distributed model training process 10 may use live results from each storage system to help mitigate the frequency at which new machine learning models are trained and evaluated.

In one example, distributed model training process 10 may detect 324 machine learning model drift and make models eligible for retraining and champion-challenger selection on a frequency of once per unit of time (e.g., every week, every month, every two months, etc.). For example, distributed model training process 10 may generate 316 a new weighted SMAPE value for each individual storage system using only the current champion machine learning model for that storage system. The weighted SMAPE value may be compared against the historical SMAPE value for the champion machine learning model. If the deviation between the two values is greater than a threshold (e.g., 20%), a new champion-challenger selection process (e.g., champion-challenger process 410) may be performed 306 for the target storage system.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer- usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
generating a plurality of trained machine learning models using a cloud computing system by training a plurality of machine learning models to forecast storage performance for one or more storage objects of a storage system, wherein the cloud computing system is separate from any storage system;
selecting a trained machine learning model from the plurality of trained machine learning models to deploy to a target storage system; and
deploying the trained machine learning model on the target storage system.

2. The computer-implemented method of claim 1, wherein selecting the trained machine learning model from the plurality of trained machine learning models includes performing a champion-challenger process with the plurality of trained machine learning models.

3. The computer-implemented method of claim 2, wherein the champion-challenger process includes:
generating a short-term forecast with each trained machine learning model;
generating a long-term forecast with each trained machine learning model;
determining a weighted symmetric mean absolute percentage (SMAPE) for the short-term forecast of each trained machine learning model;
determining a weighted SMAPE for the long-term forecast of each trained machine learning model; and
generating a weighted total SMAPE for each trained machine learning model.

4. The computer-implemented method of claim 1, wherein selecting the trained machine learning model from the plurality of trained machine learning models includes selecting the trained machine learning model using a static ruleset that describes one or more model inference performance constraints associated with the target storage system.

5. The computer-implemented method of claim 1, further comprising:
receiving a model inference result associated with the deployment of the trained machine learning model on the target storage system.

6. The computer-implemented method of claim 5, further comprising:
updating the trained machine learning model using the cloud computing system based upon, at least in part, the model inference result.

7. The computer-implemented method of claim 6, wherein updating the trained machine learning model includes detecting a drift in performance associated with the trained machine learning model.

8. A computer program product residing on a non-transitory computer readable medium having a plurality of instructions stored thereon which, when executed by a processor, cause the processor to perform operations comprising:
generating a plurality of trained machine learning models using a cloud computing system by training a plurality of machine learning models to forecast storage performance for one or more storage objects of a storage system, wherein the cloud computing system is separate from any storage system;
selecting a trained machine learning model from the plurality of trained machine learning models to deploy to a target storage system; and
deploying the trained machine learning model on the target storage system.

9. The computer program product of claim 8, wherein selecting the trained machine learning model from the plurality of trained machine learning models includes performing a champion-challenger process with the plurality of trained machine learning models.

10. The computer program product of claim 9, wherein the champion-challenger process includes:
generating a short-term forecast with each trained machine learning model;
generating a long-term forecast with each trained machine learning model;
determining a weighted symmetric mean absolute percentage (SMAPE) for the short-term forecast of each trained machine learning model;
determining a weighted SMAPE for the long-term forecast of each trained machine learning model; and
generating a weighted total SMAPE for each trained machine learning model.

11. The computer program product of claim 8, wherein selecting the trained machine learning model from the plurality of trained machine learning models includes selecting the trained machine learning model using a static ruleset that describes one or more model inference performance constraints associated with the target storage system.

12. The computer program product of claim 8, wherein the operations further comprise:
receiving a model inference result associated with the deployment of the trained machine learning model on the target storage system.

13. The computer program product of claim 12, wherein the operations further comprise:
updating the trained machine learning model using the cloud computing system based upon, at least in part, the model inference result.

14. The computer program product of claim 13, wherein updating the trained machine learning model includes detecting a drift in performance associated with the trained machine learning model.

15. A computing system comprising:
a memory; and
a processor configured to generate a plurality of trained machine learning models using a cloud computing system by training a plurality of machine learning models to forecast storage performance for one or more storage objects of a storage system, wherein the cloud computing system is separate from any storage system, to select a trained machine learning model from the plurality of trained machine learning models to deploy to a target storage system, and to deploy the trained machine learning model on the target storage system.

16. The computing system of claim 15, wherein selecting the trained machine learning model from the plurality of trained machine learning models includes performing a champion-challenger process with the plurality of trained machine learning models.

17. The computing system of claim 16, wherein the champion-challenger process includes:
generating a short-term forecast with each trained machine learning model;
generating a long-term forecast with each trained machine learning model;
determining a weighted symmetric mean absolute percentage (SMAPE) for the short-term forecast of each trained machine learning model;
determining a weighted SMAPE for the long-term forecast of each trained machine learning model; and
generating a weighted total SMAPE for each trained machine learning model.

18. The computing system of claim 15, wherein selecting the trained machine learning model from the plurality of trained machine learning models includes selecting the trained machine learning model using a static ruleset that describes one or more model inference performance constraints associated with the target storage system.

19. The computing system of claim 15, wherein the processor is further configured to:
receive a model inference result associated with the deployment of the trained machine learning model on the target storage system.

20. The computing system of claim 19, wherein the processor is further configured to:
update the trained machine learning model using the cloud computing system based upon, at least in part, the model inference result.
